(19) United States
(12) Patent Application Publication
(10) Pub. No.: US 2003/0161415 A1
(43) Pub. Date: Aug. 28, 2003

(54) Iterative channel tracking

(76) Inventor: Eyal Krupka, Ramat-Gan (IL)

Correspondence Address: FISH & RICHARDSON, PC, 4350 LA JOLLA VILLAGE DRIVE, SUITE 500, SAN DIEGO, CA, 92122, US

(21) Appl. No.: 10/086,198

(22) Filed: Feb. 26, 2002

(51) Int. Cl. H04L 27/06

(52) U.S. Cl. 375/340; 375/350

(57) ABSTRACT

Methods and apparatus for iteratively tracking channel taps in a non-stationary communications channel subject to multipath fading. Training data transmitted through the communications channel are used to determine an initial set of channel taps. A time dependent channel tap model is initialized with the initial set of channel taps. The channel tap weight is programmed into an equalizer that uses the model to estimate unknown data symbols in the received data. The estimated data symbols are used to generate a plurality of adaptively updated sets of channel taps. The plurality of adaptively updated sets of channel taps are fit to a time-dependent channel tap model to update the model parameters. The final channel tap model can then be used by the equalizer to reliably estimate unknown data symbols in the received data.

### BACKGROUND

This invention relates to methods and apparatus for determining the channels taps for a communications channel in a communications system.

In communications systems, data is transmitted from a source to a receiver through a communications channel established between the source and receiver. Typically, the communications channel distorts or filters the data that is transmitted through it. As a result, the received data looks like a filtered version of the transmitted data. The transmitted data can be faithfully recovered from the received data by passing the transmitted data through an equalizer that removes the communications channel's distortive effects.

In general, to remove the distortive effects of a communications channel, an equalizer must be programmed with the communications channel's channel taps. Typically, these channel taps are not known, however, they can be estimated from a received data stream if the received data contains training data. Training data are known data sequences that are transmitted to a receiver at known times, such as at predetermined locations within a fixed length data burst transmitted to the receiver. The channel taps of a communications channel can be estimated from training data using well-known signal processing techniques such as the least squares (LS) algorithm or weighted least squares (WLS) algorithm.

The channel taps found using the LS or WLS algorithm can be programmed into an equalizer, and used to recover all of the data in a data burst transmitted through the communications channel provided the data was transmitted in a stationary environment. A stationary environment is an environment in which the source, receiver, and any sources of interference are stationary. In a stationary environment, the channel taps of the communications channel are relatively constant in time throughout the transmitted data burst. As a result, the channel taps estimated from the training data can be programmed into the equalizer, and used to recover all of the data in the data burst without being updated.

By contrast, in a non-stationary environment, the channel taps of the communications channel can vary appreciably in time over the duration of the transmitted data burst. In a non-stationary environment, the time dependence of the channel taps can be large enough that the channel taps derived from the training data and programmed into the equalizer must be adaptively updated in order for the equalizer to accurately recover all of the data in the data burst.

In modern wireless communications systems, data is often communicated in non-stationary environments. For example, in cellular communications systems a stationary base station (source) may communicate with a receiver that is in relative motion with the base station. Thus, a need exists for determining the temporal variation of the channel tap weights of the communications channel through which a data burst is transmitted, so that all of the data in the data burst can be reliably recovered.

### DESCRIPTION OF DRAWINGS

FIG. 1 is a schematic illustration of a DSP within which the present invention can be implemented.

FIG. 2 is a schematic illustration of a data burst received by a receiver containing the DSP shown in FIG. 1.

FIG. 3 is a flow chart of a method used by the DSP shown in FIG. 1 for determining the channel tap time dependence of the communications channel through which the data burst shown in FIG. 2 is transmitted.

Like reference symbols in the various drawings indicate like elements.

### DETAILED DESCRIPTION

A digital signal processor (DSP) 100 within which the present invention may be implemented is illustrated in FIG. 1. DSP 100 can be a component in any wireless receiver that is configured to receive one or more bursts of data from a wireless transmitter. The wireless receiver is configured to digitally sample each received data burst, and pass the resulting input data stream y(k) 120 (where k is an integer value corresponding to the sampling time of the received signal) to the DSP 100. DSP 100 is configured to recover the transmitted data stream from the input data stream y(k) 120 by passing the input data stream y(k) 120 through an equalizer 160 programmed with the channel taps of the communications channel through which the received data burst was transmitted.

Since the channel taps of the communications channel are generally not known, they must be estimated from the input data stream y(k) 120. An initial set of channel taps can be found by passing input data stream y(k) 120 through an initial channel estimator 150 at times when the input data stream y(k) 120 is known to contain a training data stream. The initial channel estimator 150 can use well-known signal processing techniques such as the LS or WLS algorithms to estimate the initial set of channel taps {hⱼ} from the input data stream y(k) 120 and a locally generated copy of the training data stream d(k) 110.

The initial set of channel taps found by the initial channel estimator 150 can be programmed into equalizer 160 to recover all of the data transmitted through the communications channel in a data burst, whenever the data is transmitted in a stationary environment. When the data is transmitted in a non-stationary environment, DSP 100 can run one or more algorithms in a channel tracker 170 to adapt the initial set of channel taps {hⱼ} to account for changes in the communication channel's non-stationary radiofrequency (RF) environment. For example, DSP 100 can run the Least Mean Square (LMS) algorithm in channel tracker 170 to update the channel tap vector \vec{h}(k) that is programmed into equalizer 160. The LMS algorithm allows the channel tap vector \vec{h}(k) to be determined from a previous channel tap vector \vec{h}(k−1) according to:

\vec{h}(k)=\vec{h}(k−1)+μ·e(k)\vec{s}(k) (1)

where \vec{h}(k) is a column vector of the estimated channel taps at the time of symbol k; \vec{h}(k−1) is a column vector of the estimated channel taps at the time of previous symbol k−1; μ is the LMS step size chosen to assure convergence of the LMS algorithm; e(k) is the difference between the expected signal and the received signal; and \vec{s}(k) is the complex conjugate of the last L modulated symbols at the time of symbol k, where L is the channel length of the communications channel. The difference e(k)can be found from:

e(k)=\vec{s}^{H}(k)·h(k)−y(k) (2)

where y(k) is the received signal sample at the time of symbol k, and \vec{s}^{H}(k) is the Hermitian conjugate or complex conjugate transpose of \vec{s}(k). When the values of \vec{s}(k) are derived from the output of equalizer 160, a decision-directed adaptive channel tracking process can be developed.

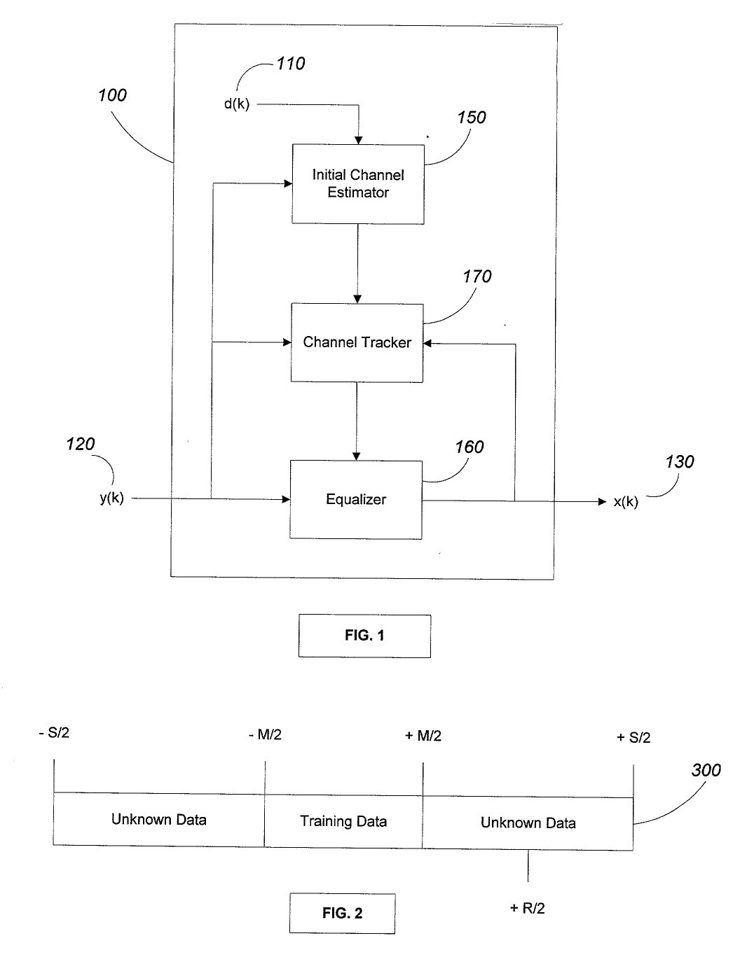

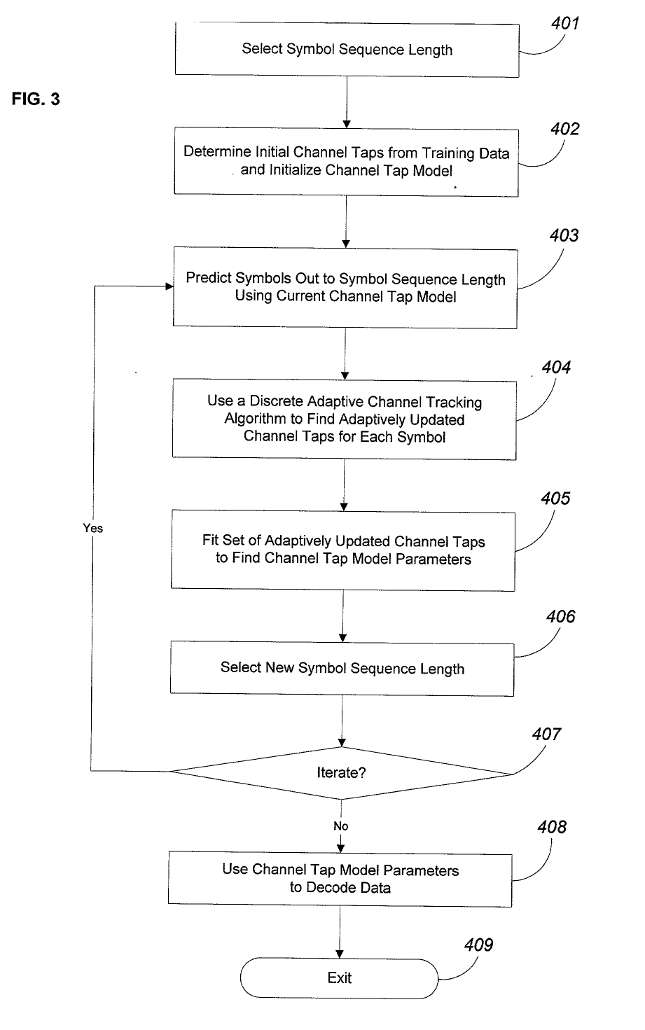

Using the LMS algorithm, channel tracker 170 can adaptively update or track the channel taps programmed into equalizer 160 on a discrete or per symbol basis. The LMS algorithm allows channel tracker 170 to calculate a new set of channel taps {hⱼ} for each symbol received in input data stream y(k) 120. Channel tracker 170 can also be used to track the channel taps that are programmed into equalizer 160 on a continual basis using the method disclosed below in reference to FIGS. 2 and 3.

FIG. 2 is a schematic illustration of a data burst 300 that can be transmitted to a receiver having a DSP 100 in which the algorithm disclosed in FIG. 3 can be implemented. The data burst 300 includes S symbols, of which M symbols (where M<S) are training data symbols. The M training data symbols can be centered in the middle of the data burst, as shown. An arbitrary time scale can be associated with data burst 300 such that the middle training data symbol arrives at time t=0, and all other symbols arrive at times t=k, where k is the symbol number or sampling interval. Thus, the first symbol in the data burst arrives at time −S/2, while the last symbol arrives at time S/2, as shown. Similarly, the first training symbol in the data burst arrives at time −M/2 while the last training symbol arrives at time M/2.

FIG. 3 is a flow chart of an iterative, decision-directed method that can be used by channel tracker 170 to program a channel tap model into equalizer 160. Through the channel tap model developed by channel tracker 170, equalizer 160 is able to continually track the time-dependence of the channel taps used to recover data transmitted through a communications channel. In general, the channel taps of the communications channel can be modeled to have an arbitrary time dependence, and can each be characterized by a fixed number of independent parameters. For example, the channel taps can be modeled to have a linear, cubic, quadratic, or sinusoidal time dependence that can be respectively characterized by 2, 3, 4, or 3 independent parameters. Channel tracker 170 can obtain sets of iteratively updated channel taps using the LMS algorithm as explained above, and can fit these sets of updated channel taps to a time-dependent channel tap model to determine the parameters of the channel tap model.

For example, in one embodiment channel tracker 170 can program channel taps having a linear time dependence into equalizer 160. In this embodiment, the relationship between the channel tap vector at time t and the channel tap vector at time t=0 can be expressed as:

\vec{h}(t)=\vec{a}·t+\vec{h}₀ (3)

The channel tracker 170 can adaptively update, one or more times, the initial channel tap vector found at time t=0 by the initial channel estimator 150, to determine the channel tap model parameters (e.g., the intercept vector \vec{h}₀, and the slope vector \vec{a}). If the channel tap vector found at t=0 is adaptively updated a single time (e.g., at time t=R/2 where R is an arbitrary sample number) the channel tap vector at time t can be written as:

$${h}^{->} ( t ) = \frac{2 \cdot t}{R} ( {h}^{->} ( R / 2 ) - {h}^{->} ( 0 ) ) + {h}^{->} ( 0 ) \qquad ( 4 )$$

If the channel tap vector is adaptively updated two or more times by channel tracker 170, the slope and intercept vectors of the channel tap model cannot be uniquely determined. Instead, optimal slope and intercept vectors can be found from the initial channel tap vector and the two or more adaptively updated channel tap vectors by fitting them to the linear channel tap model, e.g., by using a linear regression.

In general, once the time-dependent channel tap model parameters are found, channel tracker 170 can load the channel tap model parameters into the equalizer 160. DSP 100 can then determine the symbols in input data stream y(k) 120 at any time t=k by computing the channel tap vector at time t=k from the channel tap model and the loaded model parameters (e.g. using Eq. (3)), and running the input data stream y(k) 120 through the equalizer 160. The output data stream x(k) 130 from equalizer 160 can be used to predict the transmitted data symbol at the time t=k.

A method for iteratively determining the parameters of the time dependent channel tap model are shown below in FIG. 3. The method begins by selecting a symbol sequence length R that is larger than the training data sequence length M (step 401). The symbol sequence length determines the number of non-training data symbols that are first estimated (hard decision), and then used as predictors to determine adaptively updated tap weights at times corresponding to the symbol times. The symbol sequence length can be optimized for particular systems in which the algorithm is implemented, or for particular RF environments within which the systems are operated. In one implementation, the symbol sequence length is initially chosen to be slightly larger than the training data sequence length.

Once the symbol sequence length is chosen, an initial set of channel taps is determined by the initial channel estimator 150 using data received in the training data range [−M/2, M/2] and a locally generated training data stream d(k) 110. The initial set of channel taps, corresponding to time t=0, is used to initialize the intercept vector of the channel tap model. The slope of the channel tap model is initialized to zero, and the initialized slope and intercept vectors of the channel tap model are programmed into equalizer 160 by the initial channel estimator 150 (step 402).

The channel tap model is subsequently refined in iterative steps 403-407 as described below. First, equalizer 160 uses its current channel tap model to calculate the channel taps for the unknown symbols in the data burst ranges [−R/2, −M/2] and [M/2, R/2]. Equalizer 160 uses the calculated channel taps to estimate the unknown symbols in the input data stream y(k) 120 (step 403). For example, equalizer 160 can estimate data symbol x(k) from input data stream y(k) 120 using the channel tap vector predicted from equalizer 160's current channel tap model at time t=k, namely, \vec{h}(k)=\vec{a}·k+\vec{h}₀.

The unknown data symbols estimated with the current channel tap model in step 403 can then be appended to the M-symbol locally generated training data stream d(k) 110 to effectively extend the training data stream from M symbols to R symbols. The R-symbol extended training data stream can then be used by channel tracker 170 to find sets of adaptively updated channel taps, where each set corresponds to the channel taps for one of the R symbols in the extended training data stream (step 404). For example, in one embodiment the channel estimator 170 uses the LMS algorithm to adaptively update the channel tap vector found at time t=0 to find iteratively updated channel tap vectors corresponding to the time of receipt of each of the R symbols in the R-symbol extended training data stream.

The adaptively updated channel tap vectors obtained in step 404 can then be fit to a time-dependent channel tap model to determine the channel tap model parameters (step 405). For example, when the channel tap model is a linear model, the channel tap vectors obtained in step 404 can be fit to the channel tap model using a linear regression to obtain the channel tap model's slope \vec{a} and intercept \vec{h}₀ vectors. Once the channel tap model parameters are determined, a new symbol sequence length R′ is chosen (step 406), and a decision is made whether to proceed with an additional iteration of the channel tap tracking algorithm (step 407).

The decision to iterate the channel tap tracking algorithm can be based on any of a number of criteria. For example, the algorithm can be pre-programmed to perform a fixed number of iterations per data burst. Or, the algorithm can be programmed to iterate until a symbol sequence length chosen in step 406 is larger than the number of symbols in the received data burst y(k) 120.

In general, the symbol sequence length chosen in step 406 is increased in each iteration of the channel tap tracking algorithm. In one embodiment, the symbol sequence length is progressively increased with increasing iterations of the channel tap tracking algorithm. For example, in one embodiment, the channel tap tracking algorithm is configured to model the time-dependence of the channel taps over the course of a 100 symbol data burst containing a 26-symbol training data sequence. In that embodiment, three iterations of steps 403-407 are performed to determine the channel tap model parameters, and the symbol sequence length is progressively chosen to be 30 symbols, 60 symbols, and finally 100 symbols to encompass all of the symbols in the 100-symbol data burst.

If the channel tap tracking algorithm is iterated at step 407, steps 403-407 are repeated in channel tracker 170 to refine the estimates of the channel tap model parameters using data in the new data range [−R′/2, −M/2] and [M/2, R′/2]. In one embodiment, all of the symbols in the new data range are predicted in step 403 and used to find adaptively updated channel taps in step 404. Predicting all of the symbols in the new data range reduces the symbol error rate in symbols that are close to the training data sequence, thereby reducing the error in the updated channel taps estimated in step 404.

In another embodiment, only a subset of the symbols in the new data range [−R′/2, −M/2] and [M/2, R′/2] are predicted in step 403 and used to adaptively update the channel taps in step 404. For example, in one embodiment, only symbols in the data range [−R′/2, −R/2−1] and [R/2+1, R′/2] are predicted in step 403 and used in step 404. In another embodiment, symbols predicted in the data range [−R′/2, −R/2−1] and [R/2+1, R′/2] in the current iteration of step 403, and in the data range [−R/2, −M/2] and [M/2, R/2] in the previous iteration of step 403, are used to adaptively update the channel taps in step 404. In these embodiments, the number of computations required to iteratively update the parameters of the channel tap model in steps 403-407 can be significantly reduced since it is often true that the computational complexity of step 403 is much higher than the computational complexity of step 404. While these embodiments tend to reduce the overall performance of the channel tap tracking algorithm, they are useful modifications whenever CPU resources are scarce.

If at step 407, the channel tap tracking algorithm is not iterated, the channel tap model parameters most recently determined in step 405 are programmed into equalizer 160. Equalizer 160 then uses the channel tap model parameters to continually update and program the channel taps to accurately recover data from the input data stream y(k) 110 (step 408). After programming the channel tap model parameters into equalizer 160, the channel tap tracking algorithm exits (step 409).

The invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASIC's (application-specific integrated circuits), including digital signal processors.

A number of embodiments of the invention have been described. Nevertheless, it will be understood that various modifications may be made without departing from the spirit and scope of the invention. Accordingly, these and other embodiments are within the scope of the following claims.

What is claimed is:

1. A method for determining communication channel taps, comprising:
initializing the parameters of a channel tap model;
calculating one or more sets of channel taps from the channel tap model;
using the one or more sets of channel taps to estimate one or more symbols in a received data stream;
calculating one or more sets of adaptively updated channel taps from the one or more symbols estimated in the received data stream; and
fitting the one or more sets of adaptively updated channel taps to update the parameters of the channel tap model.

2. The method of claim 1, further comprising obtaining a first set of channel taps from an input data stream containing a training data stream and a locally generated copy of the training data stream; and initializing the parameters of the channel tap model with the first set of channel taps.

3. The method of claim 1, further comprising running an LMS algorithm to calculate the one or more sets of adaptively updated channel taps from the one or more estimated symbols.

4. The method of claim 1, further comprising fitting the one or more sets of adaptively updated channel taps to a channel tap model that is linear in time.

5. The method of claim 4, further comprising using a linear regression to fit the one or more sets of adaptively updated channel taps.

6. The method of claim 1, further comprising:
iteratively determining the parameters of the channel tap model; and
initializing the parameters of the channel tap model used in each iteration with the parameters determined in a previous iteration by fitting the one or more sets of adaptively updated channel taps determined in the previous iteration.

7. The method of claim 6, further comprising using the channel tap model to estimate progressively larger numbers of symbols in subsequent iterations of the method.

8. The method of claim 6, further comprising terminating the iterative method when a predetermined number of iterations have been executed.

9. The method of claim 6, further comprising terminating the iterative method when the number of symbols to estimate is greater than the number of symbols in a data burst.

10. A computer program product, implemented on a machine readable medium, for executing a channel tap tracking method, the computer program product comprising instructions operable to cause a programmable processor to:
initialize the parameters of a channel tap model;
calculate one or more sets of channel taps from the channel tap model;
use the one or more sets of channel taps to estimate one or more symbols in a received data stream;
calculate one or more sets of adaptively updated channel taps from the one or more symbols estimated in the received data stream; and
fit the one or more sets of adaptively updated channel taps to update the parameters of the channel tap model.

11. The computer program product of claim 10, further comprising instructions operable to cause a programmable processor to:
obtain a first set of channel taps using an input data stream containing training data and a locally generated copy of the training data; and
initialize the parameters of the channel tap model with the first set of channel taps.

12. The computer program product of claim 10, further comprising instructions operable to cause a programmable processor to run an LMS algorithm to calculate the one or more sets of adaptively updated channel taps from the one or more estimated symbols.

13. The computer program product of claim 10, further comprising instructions operable to cause a programmable processor to fit the one or more sets of adaptively updated channel taps to a channel tap model that is linear in time.

14. The computer program product of claim 13, further comprising instructions operable to cause a programmable processor to use a linear regression to fit the one or more sets of adaptively updated channel taps.

15. The computer program product of claim 10, further comprising instructions operable to cause a programmable processor to:
iteratively determine the parameters of the channel tap model; and
initialize the parameters of the channel tap model used in each iteration with the parameters determined in a previous iteration by fitting the one or more sets of adaptively updated channel taps determined in the previous iteration.

16. The computer program product of claim 15, further comprising instructions operable to cause a programmable processor to use the channel tap model to estimate progressively larger numbers of symbols in subsequent iterations of the channel tap tracking method.

17. The computer program product of claim 15, further comprising instructions operable to cause a programmable processor to terminate iteration of the channel tap tracking method when a predetermined number of iterations have been executed.

18. The computer program product of claim 15, further comprising instructions operable to cause a programmable processor to terminate executing the channel tap tracking method when the number of symbols to estimate is greater than the number of symbols in a data burst.

19. A receiver, configured to execute a channel tap tracking method, comprising a digital signal processor configured to:
initialize the parameters of a channel tap model;
calculate one or more sets of channel taps from the channel tap model;
use the one or more sets of channel taps to estimate one or more symbols in a received data stream;
calculate one or more sets of adaptively updated channel taps from the one or more symbols estimated in the received data stream; and
fit the one or more sets of adaptively updated channel taps to update the parameters of the channel tap model.

20. The receiver of claim 19, comprising the digital signal processor further configured to:
obtain a first set of channel taps using an input data stream containing training data and a locally generated copy of the training data; and
initialize the parameters of the channel tap model with the first set of channel taps.

21. The receiver of claim 19, comprising the digital signal processor further configured to run an LMS algorithm to calculate the one or more sets of adaptively updated channel taps from the one or more estimated symbols.

22. The receiver of claim 19, comprising the digital signal processor further configured to fit the one or more sets of adaptively updated channel taps to a channel tap model that is linear in time.

23. The receiver of claim 22, comprising the digital signal processor further configured to use a linear regression to fit the one or more sets of adaptively updated channel taps.

24. The receiver of claim 19, comprising the digital signal processor further configured to:
iteratively determine the parameters of the channel tap model; and
initialize the parameters of the channel tap model used in each iteration with the parameters determined in a previous iteration by fitting the one or more sets of adaptively updated channel taps determined in the previous iteration.

25. The receiver of claim 24, comprising the digital signal processor further configured to use the channel tap model to estimate progressively larger numbers of symbols in subsequent iterations of the channel tap tracking method.

26. The receiver of claim 24, comprising the digital signal processor further configured to terminate executing the channel tap tracking method when a predetermined number of iterations have been executed.

27. The receiver of claim 24, comprising the digital signal processor further configured to terminate executing the channel tap tracking method when the number of symbols to estimate is greater than the number of symbols in a data burst.
